(19) United States
(12) Patent Application Publication
(10) Pub. No.: US 2009/0284602 A1
(43) Pub. Date: Nov. 19, 2009

(54) MONITOR WITH CAMERAS

(75) Inventor: Yao-Wen CHU, La Palma, CA (US)

Correspondence Address: QUINTERO LAW OFFICE, PC, 2210 MAIN STREET, SUITE 200, SANTA MONICA, CA, 90405, US

(73) Assignee: TATUNG COMPANY OF AMERICA, INC., Long Beach, CA (US)

(21) Appl. No.: 12/120,197

(22) Filed: May 13, 2008

(51) Int. Cl. H04N 7/18; H04N 5/70

(52) U.S. Cl. 348/159; 348/790; 348/E07.085; 348/E05.135

(57) ABSTRACT

Monitors with cameras are provided. The monitor comprises a display unit, a plurality of cameras, and a processor. Each of the cameras captures at least one picture. The processor receives the pictures from the cameras, and simultaneously displays the pictures in the display unit.

### BACKGROUND OF THE INVENTION

1. Field of the Invention

The disclosure relates generally to monitors, and, more particularly to monitors with cameras that simultaneously display pictures captured by respective cameras.

2. Description of the Related Art

Public Viewing Monitors have been used in the surveillance market for a while now. In some cases, the Public Viewing Monitor is installed at the front of a main entrance of a retail store for theft prevention and security purposes. In such a case, when people walk by the coverage range of the camera, they will see themselves on a screen. It is believed that if potential thieves see themselves in a camera and know they are being filmed, the thieves would not choose to commit a crime at the location.

Conventionally, a Public Viewing Monitor employs a camera to capture pictures, and displays the pictures on a screen of the Public Viewing Monitor. Since the coverage range of the camera is limited, the conventional Public Viewing Monitor cannot provide a satisfactory viewing range for large retail or wholesale stores with wide entrances or exits. Additionally, the captured pictures are simply received and provided from the camera to a screen without adjustments or alterations, as conventional Public Viewing Monitors are not capable of expanding viewing range.

### BRIEF SUMMARY OF THE INVENTION

Monitors with cameras are provided.

An embodiment of a monitor comprises a display unit, a plurality of cameras, and a processor. Each of the cameras captures at least one picture. The processor receives the pictures from the cameras, and simultaneously displays the pictures in the display unit.

An embodiment of an LCD monitor comprises an LCD panel, a first camera and a second camera, and a processor. The first camera and the second camera are placed at the same side of the LCD panel. The first camera captures a first picture, and the second camera captures a second picture. The processor receives the first picture and the second picture from the first camera and the second camera, respectively, and displays the first picture and the second picture in the LCD panel

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a monitor with cameras;

FIG. 2 is a schematic diagram illustrating an embodiment of an LCD monitor with two cameras;

FIG. 3 is a flowchart of an embodiment of operations of a monitor with cameras; and

FIG. 4 is a schematic diagram illustrating an example of a monitor displaying a Panoramic scene.

### DETAILED DESCRIPTION OF THE INVENTION

Monitors with cameras are provided.

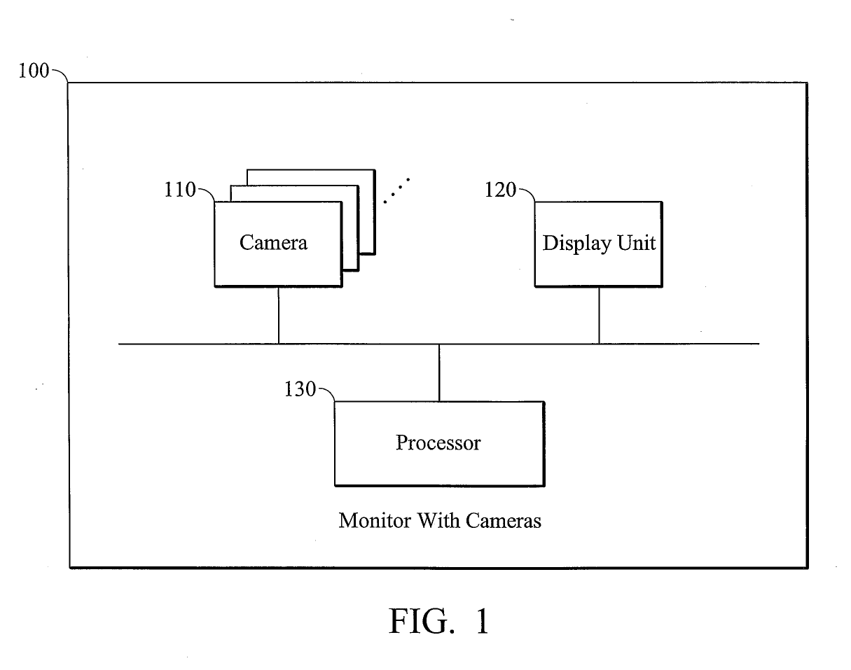

FIG. 1 is a schematic diagram illustrating an embodiment of a monitor with cameras.

The monitor with cameras 100 comprises a plurality of cameras 110, a display unit 120, and a processor 130. Each of the cameras 110 is arranged to have a corresponding coverage range. The respective cameras 110 capture pictures within the corresponding coverage range. In some embodiments, the respective cameras 110 may have motion detection capabilities. Each camera can determine whether any motion is detected within the corresponding coverage range. When motion is detected within the corresponding coverage range, picture is captured and transmitted to the processor 130. In some embodiments, the cameras 110 may be Wide Dynamic Range cameras with backlight compensation capabilities, such that the foreground in the captured pictures can be clearly seen even with a bright backlight. The processor 130 receives the captured pictures from the cameras 110, and simultaneously displays the pictures in the display unit 120. In some embodiments, the processor 130 can integrate the pictures from the cameras 110 to generate an integrated picture as a Panoramic scene, and display the integrated picture in the display unit 120. It is understood that, in some embodiments, the coverage ranges of respective cameras 110 may be overlapped. When the coverage ranges of respective cameras 110 are overlapped, the processor 130 can recognize the overlap between the pictures, and align and combine the pictures to generate the integrated picture according to the overlap.

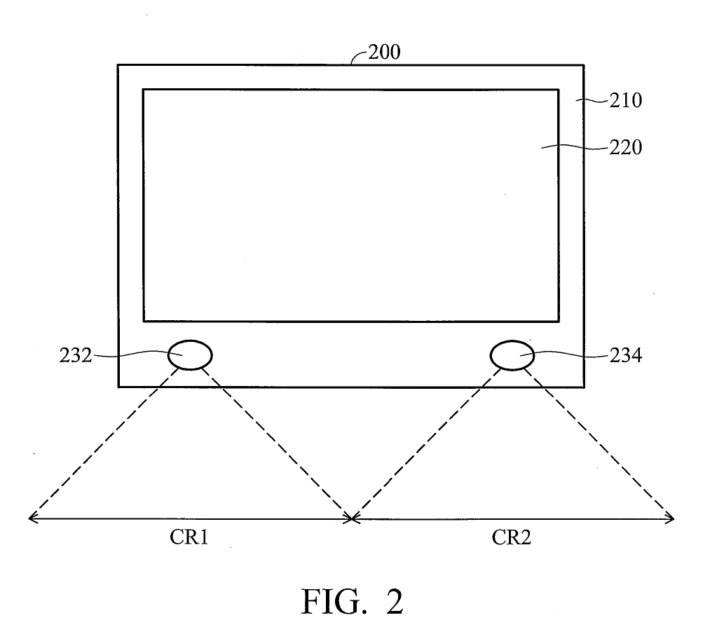

FIG. 2 is a schematic diagram illustrating an embodiment of an LCD monitor with two cameras.

As shown in FIG. 2, an LCD monitor 200 has a housing 210 containing an LCD panel 220. A first camera 232 and a second camera 234 are embedded in the housing 210. It is noted that, the first camera 232 and the second camera 234 are placed at the same side of the LCD panel 220, and have a corresponding coverage range CR1 and CR2. It is understood that, in this embodiment, the coverage ranges CR1 and CR2 are not overlapped. The pictures captured within the coverage ranges CR1 and CR2 by the first camera 232 and the second camera 234 are simultaneously displayed in the LCD panel 220.

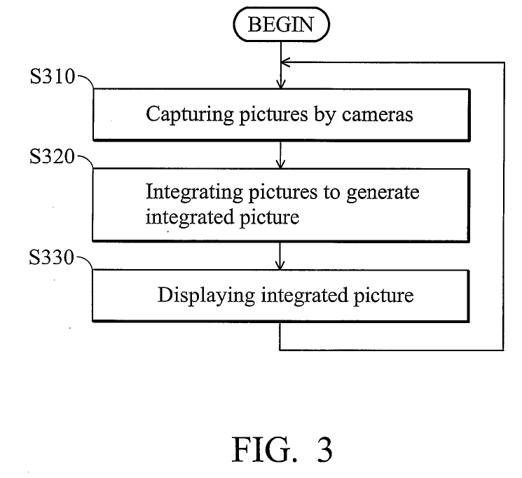

FIG. 3 is a flowchart of an embodiment of operations of a monitor with cameras.

In step S310, pictures within respective coverage ranges are captured by respective cameras 110. In some embodiments, when the respective camera 110 has motion detection capabilities, the camera 110 can determine whether any motion is detected within the corresponding coverage range. When motion is detected within the corresponding coverage range, a picture is captured and transmitted to the processor 130. In step S320, the processor 130 receives the captured pictures from the cameras 110, and integrates the pictures to generate an integrated picture. Similarly, the processor 130 can determine whether overlap exists between the pictures. When overlap exists between the pictures, the processor 130 aligns and combines the pictures to generate the integrated picture as a Panoramic scene according to the overlap. In step S330, the integrated picture (Panoramic scene) is displayed in the display unit 120.

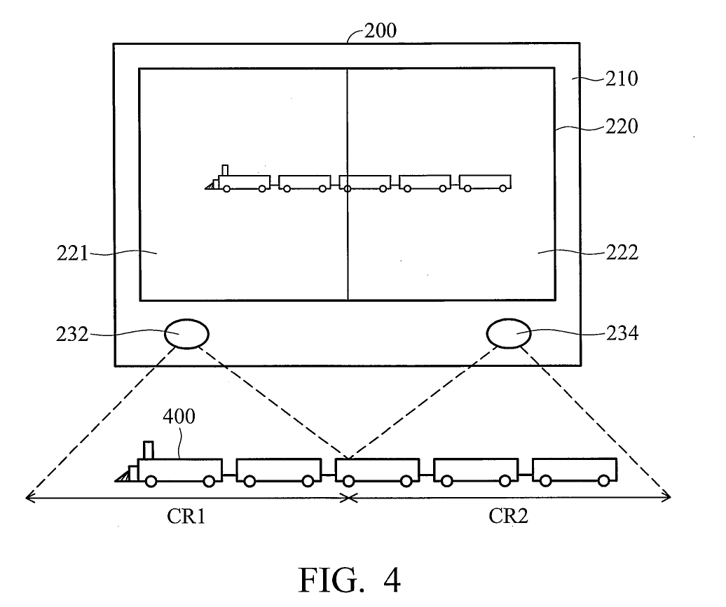

FIG. 4 is a schematic diagram illustrating an example of a monitor displaying a Panoramic scene. The pictures captured within the coverage ranges CR1 and CR2 by the first camera 232 and the second camera 234 are simultaneously displayed in the LCD panel 220, wherein the picture within the coverage range CR1 captured by the first camera 232 is displayed in a sub-screen 221 of the LCD panel 220, and the picture within the coverage range CR2 captured by the second camera 234 is displayed in a sub-screen 222 of the LCD panel 220. It is understood that the mapping between the coverage range and the sub-screen is not limited thereto. The mapping may be various for different applications. For example, the picture within the coverage range CR1 captured by the first camera 232 may be displayed in the sub-screen 222 of the LCD panel 220, and the picture within the coverage range CR2 captured by the second camera 234 may be displayed in the sub-screen 221 of the LCD panel 220. In this example, a picture including a first part of a train 400 is captured by the first camera 232, and a picture including a second part of a train 400 is captured by the second camera 234. The two pictures are integrated to generate a Panoramic scene for the train 400, and displayed in the LCD panel 220.

It is understood that, the number of the cameras can vary based on different applications. For example, in some embodiments, a monitor may be embedded with 4 cameras, and each would have a corresponding coverage range. The pictures captured by the cameras would be integrated by the processor of the monitor to generate an integrated picture to be displayed in the display unit of the monitor. Therefore, the monitor with cameras would provide an even wider range than the conventional Public Viewing Monitor with one camera structure. Additionally, the Panoramic scene integrated by the monitor with cameras can provide a satisfactory viewing range for large retail or wholesale stores with wide entrances or exits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A monitor, comprising:
a display unit;
a plurality of cameras, each capturing at least one picture; and
a processor receiving the pictures from the cameras, and simultaneously displaying the pictures in the display unit.

2. The monitor of claim 1, wherein each of the cameras is arranged to have a coverage range.

3. The monitor of claim 2, wherein each of the cameras further determines whether any motion is detected within the respective coverage range, and when motion is detected within the respective coverage range, the picture is captured and transmitted to the processor.

4. The monitor of claim 1, wherein the processor further integrates the pictures from the cameras to generate an integrated picture, and displays the integrated picture in the display unit.

5. The monitor of claim 4, wherein the processor further determines whether overlap exists between the pictures, and when overlap exists between the pictures, the processor generates the integrated picture according to the overlap.

6. The monitor of claim 1, wherein the cameras are placed at the same side of the display unit.

7. The monitor of claim 1, wherein the cameras are embedded in a housing containing the display unit.

8. The monitor of claim 1, wherein the display unit comprises an LCD panel.

9. An LCD monitor, comprising:
an LCD panel;
a first camera and a second camera, placed at the same side of the LCD panel, wherein the first camera captures a first picture, and the second camera captures a second picture; and
a processor receiving the first picture and the second picture from the first camera and the second camera, respectively, and displaying the first picture and the second picture in the LCD panel.

10. The LCD monitor of claim 9, wherein the first camera has a first coverage range and the second camera has a second coverage range.

11. The LCD monitor of claim 10, wherein the first camera further determines whether any motion is detected within the first coverage range, and when motion is detected within the first coverage range, the first picture is captured and transmitted to the processor.

12. The LCD monitor of claim 10, wherein the second camera further determines whether any motion is detected within the second coverage range, and when motion is detected within the second coverage range, the second picture is captured and transmitted to the processor.

13. The LCD monitor of claim 9, wherein the processor further aligns the first picture and the second picture to generate a Panoramic scene, and displays the Panoramic scene in the LCD panel.

14. The LCD monitor of claim 9, further comprising a housing containing the first camera, the second camera, and the LCD panel.
